(19) United States
(12) Patent Application Publication
(10) Pub. No.: US 2005/0097288 A1
(43) Pub. Date: May 5, 2005

(54) System and method for monitoring and non-disruptive backup of data in a solid state disk system

(76) Inventor: Richard Holzmann, Katy, TX (US)

Correspondence Address: Adam D. Sheehan;Building ll, Suite 201, 6500 River Place Blvd., Austin, TX, 78730, US

(21) Appl. No.: 10/697,590

(22) Filed: Oct. 30, 2003

(51) Int. Cl. G06F 12/16

(52) U.S. Cl. 711/162; 711/103

(57) ABSTRACT

The invention is directed to a system and method for monitoring data disposed on a memory module in a solid state disk system, and copying the data to a storage means without disrupting the availability, performance or use of the solid state disk system. The system preferably uses a control module coupled to the memory module and storage means. The control module preferably maintains a segment queue to record a list of data segments that have been updated in the memory module. When a time interval expires, the control module copies the data segments listed in the segment queue to the storage means.

### BACKGROUND OF THE INVENTION

1. Field of the Invention

The invention is directed generally to solid state disk systems. More specifically, the invention is directed to a system and method for monitoring data disposed on a memory module in a solid state disk system, and copying the data to a storage means without disrupting the availability, performance or use of the solid state disk system.

2. Description of Related Art

The use of solid state disk (SSD) systems allows organizations to obtain increased returns from their IT hardware investments. SSD systems allow centralized storage and retrieval of data and have many advantages over individual workstations or servers that use conventional storage systems, such as conventional rotating disks or tape drives. SSDs can move much larger amounts of data and process far more I/O requests, per time period, than conventional disk systems found on most server computers. This allows users to complete single data transactions much more quickly than with conventional disk systems.

SSD systems also provide greater reliability compared to disks, reducing downtime, and they allow for centralized management of data storage and performance, thereby reducing staffing needs. Additionally, the scalability of a SSD system also allows a user to build a storage area network (SAN) based upon the SSD's performance capacities. This allows for consolidated management of data storage and can create a virtual, dynamic resource that can be used for specific tasks by separate business units, as needed. As a result, many businesses and other organizations and enterprises are incorporating SSD systems into their IT configurations.

Solid state disk systems typically comprise a temporary memory module, such as a random access memory (RAM); a battery supported power system; and a non-volatile (conventional disk) storage means. In the event of a power outage or other shutdown, data is automatically copied from the memory module to the storage means. When power is restored, the data is re-written from the storage means to the memory module upon start-up. Solid state disk systems may also comprise control devices that allow users to manually backup data from the memory module to the storage means. Solid state disk systems may also comprise communication controllers, such as Fibre Channel (FC) controllers or FCIP mechanisms, for managing data communication with external computing devices.

Despite their many advantages, one limitation of SSD systems is the timing for backup of data from the memory module to the storage means. Typically, data is only written to the storage means when the system is shut down or otherwise taken offline, or when failure of an external power supply occurs. Not only does this result in a higher probability that data will be lost, contain errors and deficiencies, or lack synchronization, but also in a higher probability that the data lost or corrupted during backup will not be recoverable.

As a result, there is a great need in the art for a system and method for monitoring data disposed on a memory module of a solid state disk system, and copying the data from the memory module to a storage means without disrupting the use or availability of the solid state disk system. The system and method must detect when data disposed on the memory module is added to or changed and provide for copying such data to the storage means without preventing a user from continuing to use the solid state disk system. Furthermore, there is a need for a system which allows the user to determine when, and how often, the system copies the data to the storage means.

### SUMMARY OF THE INVENTION

The present invention is directed to a system and method for monitoring data disposed on a memory module in a solid state disk system, and copying the data to a storage means without disrupting the availability, performance or use of the solid state disk system. The invention overcomes limitations of prior SSD systems, by monitoring data disposed on a memory module, detecting when the data is has been added to or changed, and copying the data to a storage means. The invented system and method provide for performing such copying without disrupting use, performance or availability of the SSD system, unlike shutdown or taking the system offline. This provides greater reliability and availability with respect to backup of data on the storage means.

Furthermore, the invention permits the timing of the copying of the data to the storage means to be defined by the system user. This permits greater flexibility in system applications. Furthermore, permitting the user to define the timing interval between copying of data promotes greater system reliability and durability.

These and other advantages of the present invention will be readily apparent to those skilled in the art from the detailed description below.

### BRIEF DESCRIPTION OF THE DRAWINGS

FIG. 1 is a functional diagram illustrating a system for monitoring data disposed on a memory module in a solid state disk system and copying such data to a storage means, in accordance with the present invention.

FIG. 2 is a flow diagram illustrating steps of a method for monitoring data disposed on a memory module in a solid state disk system, and copying the data to a storage means without disrupting the availability, performance or use of the solid state disk system, which steps are implemented via the interface module illustrated in FIG. 1.

FIG. 3 is a flow diagram illustrating steps of a method for monitoring data disposed on a memory module in a solid state disk system, and copying the data to a storage means without disrupting the availability or use of the solid state disk system, which steps are implemented via the control module illustrated in FIG. 1.

### DETAILED DESCRIPTION

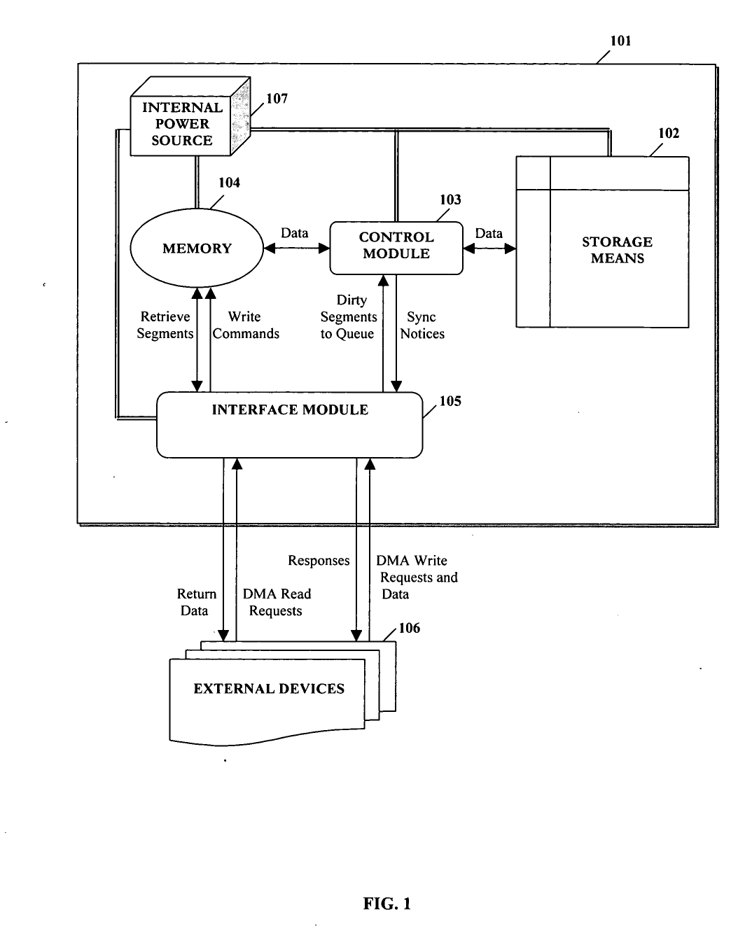

Referring now to the figures, the present invention is directed to a system and method for monitoring data disposed on a memory module in a solid state disk system, and copying the data to a storage means at user defined intervals without disrupting the availability or use of the solid state disk system. FIG. 1 is a block diagram illustrating the component parts of the invented system and the functions of each component part. The invented system comprises a solid state disk system 101 having a storage means 102, a control module 103, a memory module 104, an interface module 105 that communicates with external devices 106, and an internal power source 107.

The storage means 102 comprises a means for electronic storage of data that does not need to be periodically refreshed. The storage means 102 may comprise, for example, a hard disk system. The storage means may alternatively comprise another non-volatile storage means, such as a semiconductor memory array or flash memory array.

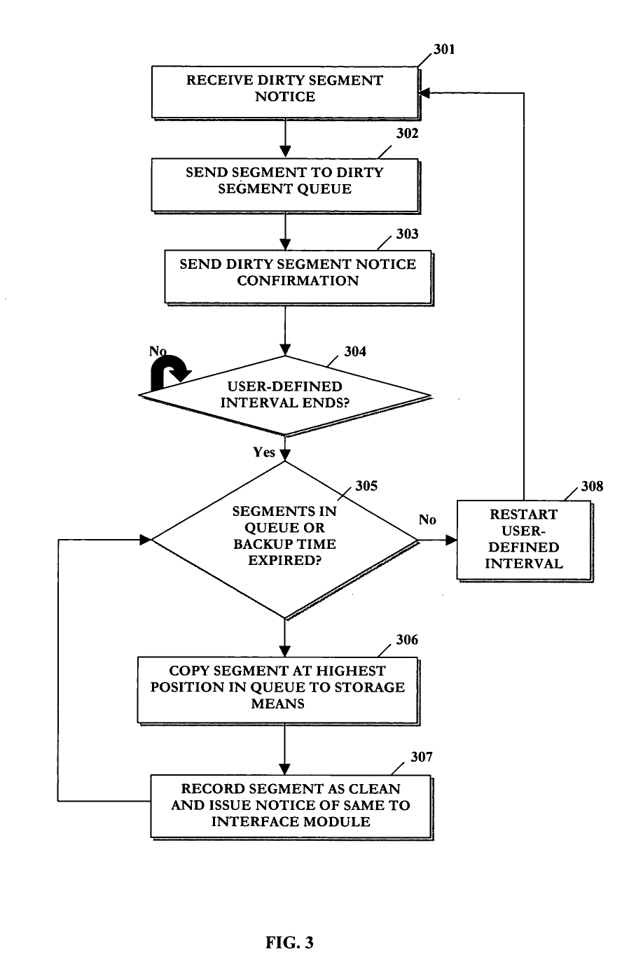

The control module 103 facilitates the copying of data to the storage means 102 from the memory module 104, and the writing of data from the storage means 102 to the memory module 104. In the present invention, the control module 103 automatically manipulates the copying and writing of data between the memory module 104 and the storage means 102, according to the method described with reference to FIG. 3. The control module 103 preferably also allows for manual manipulation of the copying and re-writing of data.

The control module 103 also maintains a dirty segment queue, which comprises a list of data segments that have been updated in the memory module 104, in response to write commands issued by the interface module 105. The dirty segment queue lists updated data segments in a prioritized order, preferably listing the earliest-updated data segment in the highest priority queue position. The prioritized order could also be optimized for sequential segments, thus increasing the efficiency of the storage means. The dirty segment queue may also be manipulated by a user to customize the priorities of the data segments listed therein.

The control module 103 further stores a user defined time interval. This time interval is used by the control module 103 to determine how often to review the dirty segment queue, and how often to copy the dirty data segments in the memory module 104.

The control module 103 preferably comprises a microprocessor-controlled solid state disk controller, the elements of which are readily known to those skilled in the art.

The memory portion 104 comprises at least one direct-access memory module for holding data currently or recently used by external devices 106. The memory module 104 is more quickly accessible, and performs read and write processing functions more quickly, than non-volatile or disk memory, such as storage means 102. The memory portion 104 preferably comprises at least one random-access memory (RAM) module. The RAM module may comprise dynamic random-access memory (DRAM), synchronous DRAM (SDRAM), double data rate (DDR) memory, or other appropriate memory technology.

The interface module 105 manages communication between the system 101 and external devices 106. The interface module 105 receives and processes read and write commands from external devices 106. Based upon commands it receives from external devices 106, the interface module 105 issues commands to the control module 103 and to the memory module 104, as the case may warrant. The interface module 105 then receives data and commands from the control module 103 and the memory module 104, and returns requested data or otherwise responds to the external devices 106.

With respect to the current invention, the interface module 105 receives data requests (read commands) from external devices 106 for particular data blocks. The interface module 105 translates these blocks into segments, retrieves the data segments from memory 104, and returns the requested data blocks to the external devices 106. The interface module 105 also receives write commands from external devices 106 to update data disposed on the memory module 104. The interface module sends corresponding write data to the memory module 104 for updating the data.

The interface module 105 also sends notices of recently updated (“dirty”) data segments disposed on the memory module 104 to the dirty segment queue maintained by the control module 103. The interface module 105 receives notices from the control module 103 when an updated data segment has been “cleaned” or copied from the memory module 104 to the storage means 102. The interface module 105 also sends responses to write request to the external devices 106. For instance, the interface module 105 may send a response to an external device indicating that data has been synchronized between the memory module 104 and the storage means 102, or indicating that the data cannot be updated or synchronized, or indicating that data has been written to the memory module.

The interface module 105 may communicate with external devices 106 via Ethernet or FC or other appropriate interface. Preferably, the interface module 105 communicates with external devices 106 via FC. The interface module 105 may comprise an application-specific integrated circuit (ASIC), such QLogic Fiber Channel ASIC. Alternatively, the interface module 105 may comprise a general integrated circuit, such that it may process requests from multiple applications and process different request protocols.

External devices 106 comprise computing devices having central processing units that are capable of submitting commands and data requests to, and receiving requested data and responses from, the interface module 105, via FC communication, Ethernet, or other appropriate communication means.

The internal power supply 107 comprises a temporary power supply suitable for providing adequate power to facilitate the copying of data from the memory 104 to the storage means 102 in the event that external power to the system 101 should fail. The internal power supply 107 may comprise, for example, at least one battery, extended-life battery pack or direct current uninterrupted power supply (DC UPS). Upon shutdown or failure of external power to the system 101, the internal power supply 107 provides sufficient power for data residing in memory 104 to be copied to the storage means 102, upon prompting by the control module 103. When power is restored and start-up of the system 101 is initiated, all or a portion of the data may be re-written from the storage means 102 to the memory 104.

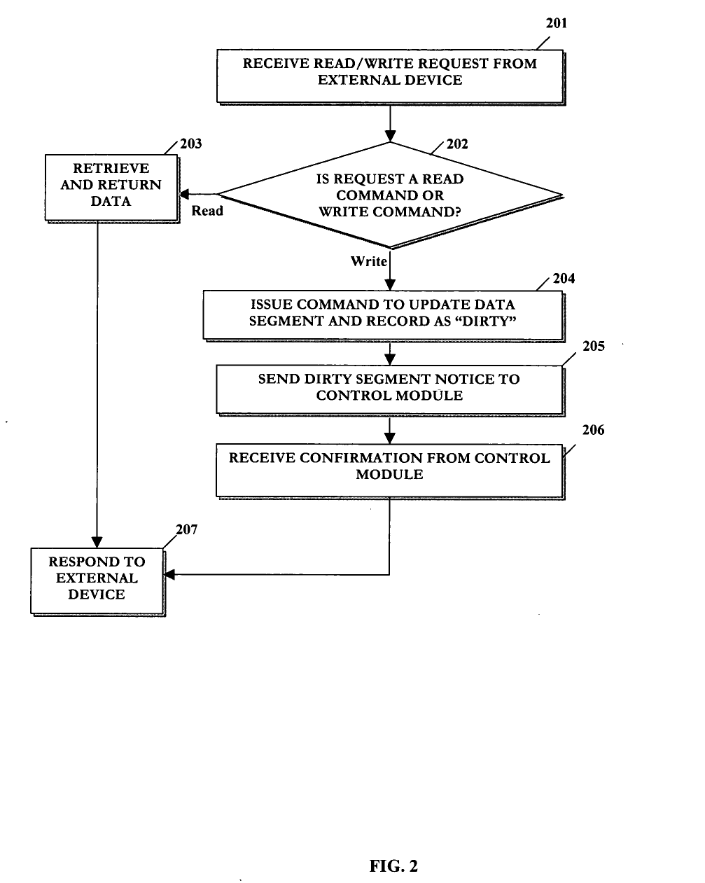

FIG. 2 is a flow diagram illustrating steps of the invented method for monitoring data disposed on a memory module in a solid state disk system, and copying the data to a storage means without disrupting the availability, performance or use of the solid state disk system, which steps are implemented via the interface module described with reference to FIG. 1. In accordance with step 201, the interface module receives a read or write request from an external device. In accordance with step 202, the interface module processes the request and determines whether the read or write request constitutes a read command or a write command.

If the read or write request constitutes a read command, i.e., a request for particular blocks of data to be returned from the memory module, then the interface module retrieves the requested data from the memory module and returns it to the external device that issued the read or write request, in accordance with step 203. The interface module may then further respond to the external module by, for example, issuing an acknowledgment that the read operation has been completed.

If the read or write request constitutes a first write command, i.e., a request that one or more data blocks in memory be updated or otherwise altered, then the interface module translates the data blocks into segments stored in memory. In accordance with step 204, the interface module issues at least one write command to the memory module to update or alter each data segment that contains any data block(s) concerned in the first write command. The interface module then records each updated segment as a “dirty” segment.

For each segment recorded as “dirty” by the interface module, the interface module issues a notice to the control module that the segment is dirty, in accordance with step 205. This may be performed by issuing a command to record the segment as dirty in the dirty segment queue maintained by the control module. After the interface module issues notice to the control module that the particular segment is dirty, then it may receive confirmation of such notice from the control module according to step 206. After confirmation of the notice has been received, the interface module may issue a notification to the external device that the write operation has been completed, according to step 207.

FIG. 3 is a flow diagram illustrating steps of a method for monitoring data disposed on a memory module in a solid state disk system, and copying the data to a storage means without disrupting the availability, performance or use of the solid state disk system, which steps are implemented via the control module described with reference to FIG. 1. In accordance with step 301, the control module receives a notice from the interface module. The notice indicates that a particular data segment disposed on the memory module has been altered or updated and marked as “dirty” by the interface module.

In accordance with step 302, the control module lists the segment identified by the notice, in the control module's dirty segment queue. The dirty segment queue comprises a listing of data segments whose data has been added or updated since the last time data was copied from the memory module to the storage means. The queue has a plurality of priority positions that indicate the order in which added or updated data segments are to be copied to the storage means the next time a backup is performed. The queue's priority positions are preferably arranged in order of time, such that the highest priority position in queue corresponds to the data segment that was altered or updated the shortest time after the previous backup. The priority positions in queue may alternatively be arranged in sequential disk order or other optimized order. In some embodiments, the dirty segment queue may be manipulated by a user, such that data segments may be moved among priority positions as defined by the user. The priority positions in the queue may also be arranged dynamically by the control module.

In accordance with step 303, the control module issues a confirmation to the interface module that the notice regarding the dirty data segment has been received by the control module. The confirmation may also indicate whether the segment has been designated within the dirty segment queue.

Next, the control module waits until a user-defined backup time occurs, in accordance with step 304. The user-defined backup time may occur constantly, periodically, at the end of a consistent time period, such as fifteen minutes, three hours, one day, or other user-defined time. Alternatively, the user-defined backup time may occur once a threshold number of data segments are identified in the dirty segment queue. Alternatively, the user-defined backup time may comprise shutdown of the system, taking the system offline, or failure of external power to the system.

Once a user-defined time occurs, the control module determines whether additional segments are still identified in the dirty segment queue, in accordance with step 305. If segments are identified in the queue, then the control module copies the data segment identified in the highest queue position to the storage means from the memory module, in accordance with step 306. The control module records the data segment as clean and sends notice that the segment is clean to the interface module, in accordance with step 307.

The control module then checks to see whether additional segments are still identified in queue, in accordance with step 305. If so, the control module repeats steps 306 and 307. The control module repeats steps 305-307 until no additional data segments are identified in queue. When no additional data segments are identified in queue, the user-defined wait time is restarted, in accordance with step 308 and the method begins again with step 301. Alternatively, the user-defined time may be restarted at the same time that the first data segment is written to the storage means.

Alternatively, the control module may keep a second dirty segment queue, to identify segments which are added to or changed while the control module has been performing the copying operations in accordance with step 306. Once the control module determines, in accordance with step 305 that no additional segments are contained in the first dirty segment queue, the control module checks to see if there are any segments identified in the second dirty segment queue. If dirty segments are identified in the second queue, the segments so identified are copied to the storage means from the memory module according to steps 306 and 307. After all of the dirty segments identified in the second dirty segment queue have been copied to the storage means, the control module can again review the first dirty segment queue, to determine whether any segments in the memory module have been added to or changed while the copying of the dirty segments identified in the second dirty segment queue was taking place. The control module then continues checking each dirty segment queue until it determines that all dirty segments have been copied to the storage means.

The embodiments of the invented system and method, as shown in the figures, have been presented for illustrative purposes only and are not intended to limit the scope of the invention. It will be appreciated by those skilled in the art that certain aspects of the invention may be changed, or steps re-ordered or omitted, without departing from the scope of the invention as a whole.

1. A solid state disk system comprising:
a non-volatile storage media;
a memory module;
an interface module for communicating with a computer network;
a control module operatively coupled to the non-volatile storage media, the memory module, and the interface module;
a segment queue stored by said control module for storing a list of data segments that have been updated in said memory module;
said control module, when a time interval expires, copying the data segments listed in said segment queue to said non-volatile storage media.

2. The system of claim 1, wherein the time interval is defined by a user.

3. The system of claim 1, wherein the time interval is determined by a threshold number of data segments listed in said segment queue.

4. The system of claim 1, wherein the memory module is a RAM module.

5. The system of claim 1, further comprising:
a temporary power supply;
upon shutdown of the system or failure of external power to the system, the control module copying the data stored in the memory module to the non-volatile storage media.

6. The system of claim 5, where upon shutdown of the system or failure of external power to the system, said temporary power supply providing power to the system.

7. The system of claim 1, wherein said segment queue lists the earliest-updated data segment in the highest priority queue position.

8. The system of claim 1, wherein said segment queue is manipulated by a user to customize the priorities of the data segments listed in said queue.

9. The system of claim 1, wherein said segment queue is dynamically arranged by said control module.

10. The system of claim 1, wherein said segment queue is arranged in sequential order corresponding to the order of memory segments in said non-volatile storage media.

11. The system of claim 1, further comprising a second segment queue for storing a list of data segments that have been updated during the time that said control module copied data segments listed in said first segment queue to said non-volatile storage media, said control module copying said data segments listed in said second segment queue to said non-volatile storage media.

12. In a solid state memory system including a non-volatile storage media, a memory module, an interface module for communicating with a computer network, and a control module, a method for monitoring and backup of data comprising the steps of:
receiving a memory access request from an external device, said memory access request identifying a particular segment in the memory module;
updating the requested data segment in the memory module;
recording in a queue that the data segment has been updated;
determining whether a preset time-interval has expired;
when said time interval has expired, copying the segments recorded in said queue to the non-volatile storage media and clearing the segment from the queue.

13. The method of claim 12 wherein said time interval is user defined.

14. The method of claim 12 wherein said time interval is determined by a threshold number of data segments listed in said segment queue.

15. The method of claim 12, further comprising the step of organizing the data segments recorded in the queue in the order the segments are recorded.

16. The method of claim 12, further comprising the step of organizing the data segments recorded in the queue in sequential order corresponding to the order of memory segments in said non-volatile storage media.
